(19) United States
(12) Patent Application Publication
(10) Pub. No.: US 2005/0286547 A1
(43) Pub. Date: Dec. 29, 2005

(54) Method and apparatus for accessing a wireless multi-carrier communication system

(76) Inventors: Kevin L. Baum, Rolling Meadows, IL (US); Vijay Nangia, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/004,358

(22) Filed: Dec. 3, 2004

Related U.S. Application Data
(60) Provisional application No. 60/582,493, filed on Jun. 24, 2004.

(51) Int. Cl. H04J 3/16; H04B 1/713; H04B 1/707; H04B 1/69

(52) U.S. Cl. 370/437

(57) ABSTRACT

A subscriber station (101-103) accesses a multicarrier communication system (100) by determining (505) one or more channel characteristics that is indicative of a range of the subscriber station from a base station, selecting (510) an access code that generates an access signal having a peak to average power ratio, using the one or more channel characteristics, generating (515) an access signal from the access code, and transmitting (525) the access signal and also by determining (405) one or more channel characteristics of each frequency sub-band of a set of frequency sub-bands, selecting (410) a frequency sub-band of the set of frequency sub-bands based on the one or more channel characteristics, and transmitting (420) the access signal on the selected frequency sub-band.

### FIELD OF THE INVENTION

The present invention relates generally to wireless communication systems, and in particular, to a method and apparatus for accessing a multi-carrier wireless communication system.

### BACKGROUND OF THE INVENTION

In a wireless communication system, it is critical to design a mechanism for allowing a remote subscriber station (SS) such as a cellular or mobile telephone to access the network by sending an access signal to a Base Station (BS). The access signal fulfills important functions such as requesting resource allocation from the BS, alerting the BS of the existence of the SS that is trying to enter the network, and initiating a process that allows the BS to measure some parameters of the SS (e.g., timing offset caused by propagation, frequency error, transmit power, etc.) that must be maintained and adjusted constantly in order to ensure a non-interfering sharing of the uplink resource. In response to the access message, a message is sent back to the SS indicating how to update the SS's local timing reference (and optionally the frequency and power reference) and what the transmission schedule is for the SS, so that subsequent transmissions from the SS will be more accurately synchronized to the BS and be essentially non-interfering with scheduled transmissions of other SS's.

Unlike ordinary data traffic that is sent using scheduled resources that are allocated to the SS, such an access signal is often transmitted in an unsolicited manner. Therefore, this process is often referred to as a random access. Sometimes the process is also referred to as ranging, such as defined in a current draft version of Institute of Electrical and Electronic Engineers, Inc (IEEE) 802.16 standards (IEEE P802.16-REVd/D5-2004), because the access signal can help the BS to measure the propagation distance from the SS (i.e., its range) so that its transmission timing can be adjusted to ensure the signals from all the SS's are synchronized at the BS (i.e., uplink timing synchronization). In this specification, the term “random access”, “access” and “ranging” will be used interchangeably to describe these processes and the signal transmitted by the SS to initiate the process.

In the systems defined in the current draft version of the IEEE 802.16 standard, the ranging transmissions of different SSs may sometimes collide. In this case, each SS randomly selects a ranging code from a large set of predefined ranging codes, and the BS relies on the processing gain of the ranging codes to detect and separate the multiple SSs that are transmitting different ranging codes at the same time.

A significant problem with the ranging scheme described above is that “near-far” problems can occur. Consider the case where an SS is on the edge of a cell and does not have sufficient transmit power to meet the received signal level that is expected at the BS for ranging transmissions. In this case, a SS performing ranging near the BS can block the ranging signal from the edge-of-cell SS even though the SS near the BS uses power control to reduce its signal level to the level expected at the BS.

One technique to improve the reliability of ranging signals is described in U.S. Application Ser. No. 60/582,602 having attorney's docket number CML01942M and filed concurrently herewith, entitled “Method and Apparatus for Accessing a Wireless Communication System”. This technique divides the channel into a set of narrower sub-bands, and by transmitting a ranging signal on one sub-band rather than using the whole channel bandwidth, a power concentration gain is achieved. For example, if the channel is divided into 10 sub-bands, then the maximum power spectral density of the edge-of-cell SS can be increased by 10 dB in those situations in which the cell location of the SS is known.

Further improvement of the reliability of ranging signals is desirable.

### BRIEF DESCRIPTION OF THE DRAWINGS

FIG. 1 is a block diagram of a communication system, in accordance with some embodiments of the present invention.

FIGS. 2 and 3 are graphs that shows typical spectrums of energy received at subscriber stations from a base station, in accordance with some embodiments of the present invention

FIG. 4 is a flow chart of a method used in a subscriber station for accessing a communication system that involves selection of a frequency sub-band, in accordance with some embodiments of the present invention.

FIGS. 5, 6 and 7 are flow charts of methods used in a subscriber station for accessing a communication system that involve selection of a ranging code, in accordance with some embodiments of the present invention.

### DETAILED DESCRIPTION OF THE INVENTION

Before describing in detail the particular communication system accessing technology in accordance with the present invention, it should be observed that the present invention resides primarily in combinations of method steps and apparatus components related to accessing a communication system by a subscriber station. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

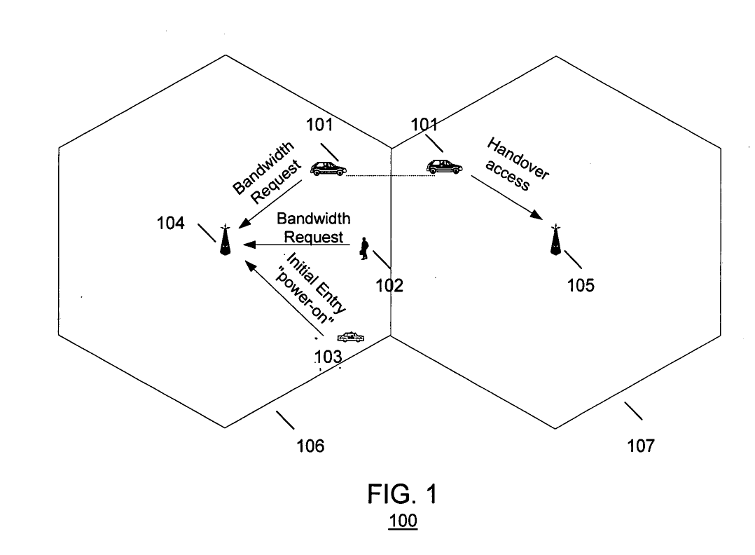

Turning now to the drawings, wherein like numerals designate like components, FIG. 1 is a block diagram of communication system 100, in accordance with some embodiments of the present invention. Communication system 100 comprises a plurality of cells 106 and 107 (only two shown) each having a base station (BS) 104, 105. The service area of the BS 104 covers a plurality of subscriber stations (SSs) 101-103, each capable of performing at least one type of ranging function, which is also called herein a random access function. For example, SS 101 may move out of the service area of BS 104 and enter into the service area of BS 105, in which case a handover occurs that often involves a handover access. In other examples, SS 102 makes a bandwidth request, SS 103 makes a “power on” access request. In one embodiment of the present invention, communication system 100 utilizes an Orthogonal Frequency Division Multiplexed (OFDM) modulation or other variants of OFDM such as multi-carrier CDMA (MC-CDMA), multi-carrier direct sequence CDMA (MC-DS-CDMA). In other embodiments of the present invention, the communication system 100 can use any arbitrary technology such as TDMA, FDMA, and CDMA, or combinations thereof.

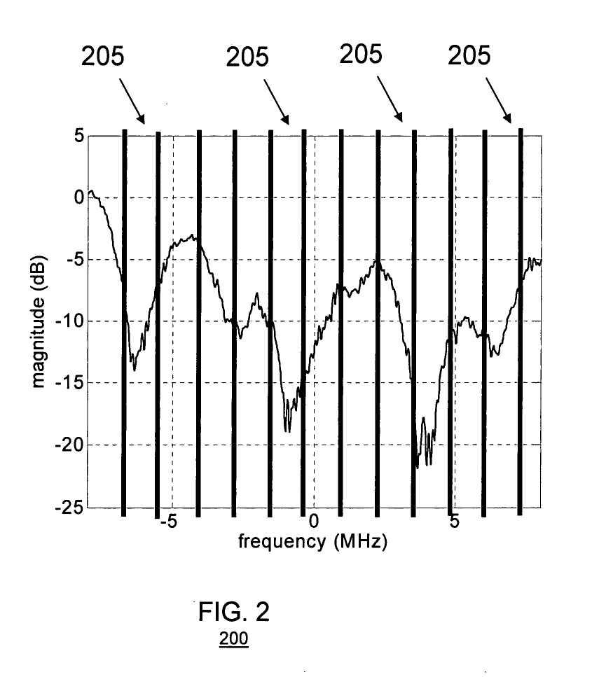

Referring to FIG. 2, a graph shows a typical spectrum of energy received at an SS from a BS that is transmitting radio frequency energy having essentially uniform density over a 15 MHz band at a center frequency of approximately 3.7 GHz. In accordance with some embodiments of the present invention, a time division duplex (TDD) communication system uses this band of frequencies, which include a plurality of 1.25 MHz TDD sub-bands 205, each of which comprises a plurality of TDD frames. The SS measures the frequency selective signal strength of each sub-band during the downlink portion of the frame, which will in general be related to the signal power received within each sub-band. Next, when the SS prepares to transmit a ranging signal in the uplink portion of a TDD frame, it preferably selects the best sub-band for its uplink ranging transmission based on the sub-band determined to have the highest received power in the downlink portion of the TDD frame (link-loss reciprocity applies, and even without RF calibration the relative magnitudes of the frequency response will be approximately the same at the same frequencies during the uplink frames and the downlink frames). Since the signal strength can vary by up to 20 dB over the total 15 MHz band in multipath delay-spread channels, this method can provide substantial power gains over a random selection of a sub-band.

Considering a system where the sub-bands are 1.25 MHz wide, it is clear from FIG. 1 that substantial gains are possible with the proposed method (about a 15 dB improvement between the worst and best sub-bands). Variations of this “best sub-band” concept, such as making a random selection among the best M sub-bands, selecting a sub-band that has a higher than average power, avoiding the K worst sub-bands, and other similar methods of selecting a favorable sub-band also fall within the scope of the present invention and could also provide significant gains.

One issue that may be considered for the proposed method is that multiple SSs may have measured the same “best sub-band” and may therefore collide on their ranging transmissions. The method proposed here is not expected to have any substantial negative impact on the number of collisions on a particular sub-band relative to a random sub-band selection process because the energy spectrums for different SSs are typically not well correlated due to their differing locations.

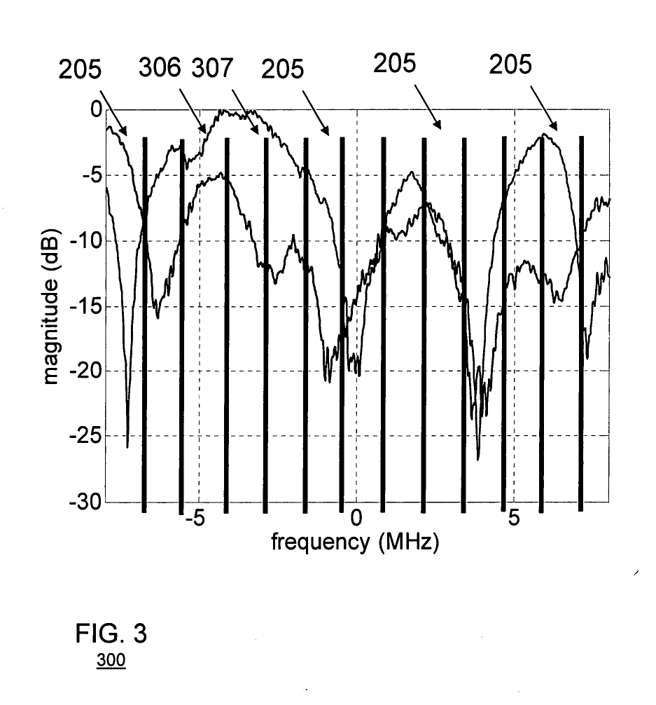

Referring to FIG. 3 a graph of a spectrum of energy shows typical measured frequency responses or frequency selective signal strengths for two SSs that are located only 1 meter apart, in the same system described with reference to FIG. 2. While there is some similarity between the overall characteristics of the responses, the some of the peaks occur on different 1.25 MHz sub-bands for the two different locations that are only 1 meter apart, and the greatest peak for each SS is found in two adjacent sub-bands 306, 307. For greater separations, the frequency responses can be expected to become even more un-correlated, and the signal strength measurements will vary accordingly.

Although signal strength measurements have been described as the characteristic used to evaluate the sub-bands, it will be appreciated that other frequency-selective channel characteristics could be used in combination with received signal strength, or as alternative characteristics on which to base a choice of a best or favorable sub-band. As an example, a measurement of received signal distortion may be appropriate for use in combination with a received signal strength. Other examples of potentially usable characteristics include a signal to noise ratio (S/N) measured over each sub-band, a signal to interference noise ratio (S/I) measured over each sub-band, a signal to interference-plus-noise ratio (S/(I+N)) measured over each sub-band, a predicted bit-error-rate, a channel response measured over each sub-band, or other measures of signal quality. Since the sub-band can be selected based on the quality of sub-bands relative to each other, such measures can also be made in a relative sense.

In order to reduce complexity, the signal strength/signal quality measurements can be made on only a subset of the total sub-bands in the channel. Also, even within a particular sub-band, measurements can be made on only a subset of the sub-carriers that are within in the sub-band for embodiments used with OFDM.

Although the above description of the present invention has been detailed within the context of a conventional TDD system, it will be also appreciated that the present invention is applicable to FDD systems, by using a modified technique in which the base station (BS) measures a frequency selective channel characteristic of a plurality of preliminary access signals sent to the BS on a plurality of uplink sub-bands and the BS identifies a favorable sub-band based on the plurality of frequency selective channel characteristics, or the BS identifies the values of the frequency selective channel characteristics in a downlink signal. The SS can then use the identified sub-band or identify the sub-band from the values, and use the identified favorable sub-band in an uplink access signal

The above described technique may also be used by a SS operating in a narrowband mode in a broadband orthogonal frequency division multiplex (OFDM) system, for the ranging process. The process is basically as follows: 1) A narrowband SS “hops” over a plurality of sub-bands during a downlink subframe defined in the broadband OFDM system, measuring a frequency selective channel characteristic at each hop, 2) the SS selects the best of the measured sub-bands, and 3) the SS uses the best sub-band for a ranging transmission in the uplink.

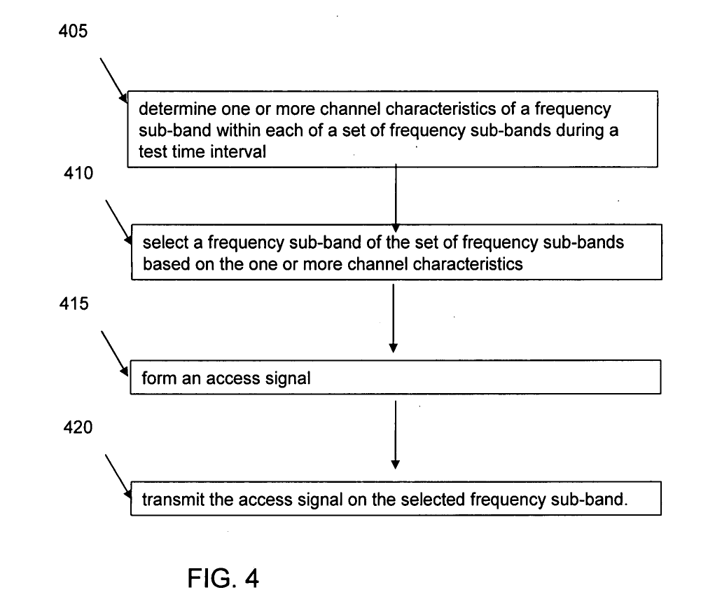

Referring to FIG. 4 a flow chart of a method used in a subscriber station for accessing a communication system that involves selection of a frequency sub-band is shown, in accordance with some embodiments of the present invention. Examples of these have described above with reference to FIGS. 1-4. At step 405, one or more channel characteristics of a frequency sub-band are determined within each of a set of frequency sub-bands during a test time interval. A frequency sub-band of the set of frequency sub-bands is selected at step 410 based on the one or more channel characteristics. At step 415, an access signal is formed, and the access signal is transmitted on the selected frequency sub-band at step 420.

Note that in the present invention, when used in a multicarrier (OFDM) system, a frequency sub-band can comprise a plurality of adjacent or closely spaced sub-carriers in one embodiment. In another embodiment, a frequency sub-band may comprise an arbitrary set of subcarriers selected from the entire set of sub-carriers in the OFDM system. For example, for the OFDMA PHY defined in the current draft version of the IEEE 802.16 standard, a sub-channel is a set of sub-carriers that are not necessarily adjacent. In the present invention, one or more OFDMA sub-channels can be used as a sub-band.

An additional aspect of the invention is a switching mechanism that can be used to select between a random sub-band selection and the frequency selective sub-band selection described above. Since there is typically a time lag between the measurement of a channel characteristic for sub-band selection and the transmission of an access signal on the selected sub-band, large channel variations during the lag time may impact the accuracy of the sub-band selection. For example, an SS may measure and select the best sub-band based on a pilot sequence or preamble transmitted at the beginning of a downlink portion of a TDD frame, and would not transmit an access signal until the uplink portion of the frame which may be 1 millisecond or more (depending on the TDD frame length) after the sub-band selection. If there are large changes in the channel frequency response during this time lag, then the frequency selective sub-band selection may not provide significant gains over a random sub-band selection. If the frequency selective sub-band selection would not provide significant gains, the processing complexity in the SS may be reduced by using the random sub-band selection rather than the frequency selective sub-band selection. In the switching aspect of the invention, an SS estimates the rate of change of one or more channel characteristics over a time period, determines whether the rate of change is greater than a threshold that would likely cause a large channel variation between the time the characteristics are measured for sub-band selection and used for transmitting an access signal on the selected sub-band, an then uses the random sub-band selection mode if a large channel variation is determined to be likely, or the frequency-selective sub-band selection mode if a large channel variation is determined to be unlikely. Note that the frequency selective sub-band selection of the present invention can increase the amount of power transferred over the channel from the SS to the BS on an access transmission. An additional aspect of the invention is to use this power gain to improve performance. In one embodiment of this aspect, the SS uses at least a portion of the power gain provided by the sub-band selection to reduce its transmit power, in order to reduce power consumption, interference to other users of the same sub-band, and increase the battery life of the SS. In an additional embodiment, the SS uses at least a portion of the power gain provided by the sub-band selection to increase the power of the received access signal at the BS, thereby making an accurate detection of the access signal at the BS more likely. In an additional embodiment, the SS sets its transmit power to achieve a desired received level at the BS, and the setting is based in part on a characteristic of the selected sub-band (such as the received signal power on the selected sub-band). Other aspects, such as power control calibration factors, may also be included for determining the transmit power setting.

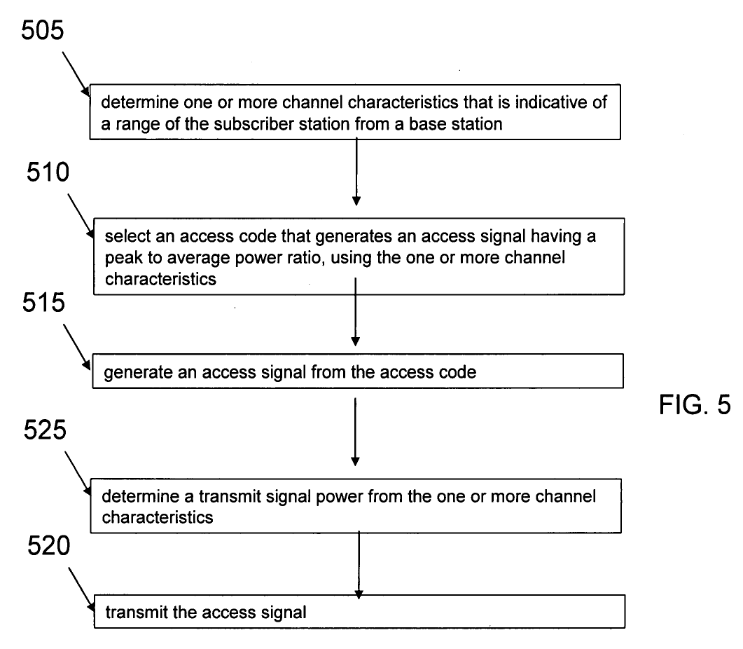

Referring to FIG. 5, a flow chart of a method used in a subscriber station for accessing a communication system that involves selection of a ranging code is shown, in accordance with some embodiments of the present invention. These embodiments are applicable to a wide variety of communication systems, including OFDM, TDD, and FDD systems, and involve selecting a ranging code from a defined set of ranging codes used by a plurality of SSs than can operate in the communication system, based in part on the peak-to-average power ratios (PAPRs) of the different ranging signals generated from the ranging codes rather than using the conventional method of choosing a ranging code (and therefore, ranging signal) randomly. In one embodiment, the ranging codes are sorted/classified by the PAPR of the ranging signal generated by the code. For example, the ranging codes may be divided into two sets: one set is the “low PAPR” set that contains all codes that generate a ranging signal with a PAPR below a predetermined threshold, and the second set is the “high PAPR” set containing the rest of the ranging codes. At step 505 of FIG. 5, the SS determines one or more channel characteristics that are indicative of a range (or path loss) of the SS from a BS that has been chosen for ranging. In one embodiment, the channel characteristics consist simply of a measured average received signal strength. In an additional embodiment, the channel characteristics consist simply of a measured path loss between the SS and BS. Such measurements can be made on substantially the entire BS transmitted signal bandwidth, or could alternatively be made on a set of sub-bands if the frequency selective sub-band selection aspect of the invention is being used. When the SS is near the edge of the cell (i.e., the channel characteristics meet a criteria indicating such a location) and does not have sufficient power available for proper transmission of a “high PAPR” ranging signal, it will instead choose a ranging code from the “low PAPR” set and boost the ranging signal transmit power by reducing the power amplifier backoff. Of course, in other embodiments, the selection could be more refined by having a plurality of sets of ranging codes related to a corresponding plurality of estimated ranges. More generally, the SS selects a ranging code (access code) that generates a ranging signal (access signal) having a PAPR, using the one or more channel characteristics to perform the selection, and in some embodiments, a relationship of the peak to average power ratio (PAPR) to the one or more channel characteristics is a monotonically increasing relationship of the PAPR to a single value determined for the one or more channel characteristics of each frequency sub-band of the set of frequency sub-band.

Then the SS generates the access signal from the access code at step 515, and transmits the access signal at step 525.

In some embodiments of the present invention, a transmit signal power of the access signal transmitted by the SS is set at step 525 based on the one or more channel characteristics. In these embodiments, a relationship of the transmit power to the one or more channel characteristics may be a monotonically decreasing relationship of the transit power to a single value determined from the one or more channel characteristics. For example, when the one or more channel characteristics consist of an average received signal strength, the transmit power may have two values that correspond to two BS to SS range estimates (e.g., low and high) determined from the average received signal strength.

In some embodiments of an OFDM system described in U.S. Application Ser. No. 60/582,602, having attorney's docket number CML01942M and filed concurrently herewith, entitled “Method and Apparatus for Accessing a Wireless Communication System”, PAPRs of 148 ranging signals that are generated from GCL sequences (each sequence is one “ranging code”) are between 2.39 and 6.29 dB, but in some embodiments only the best 32 ranging codes are described as being used to generate ranging signals (the best 32 codes result in a PAPR from 2.39 to 3.46 dB). While this provides substantial improvement (higher probability of successful ranging signal decoding by the BS) over other conventional methods for many system configurations, the probability of successful ranging signal decoding may be further improved by using the present invention and allowing all of the 148 GCL codes to be used, rather than just the best 32. This greatly reduces the probability that two SSs would select exactly the same ranging code in the same sub-band. The best 32 ranging codes would be placed in a “low PAPR” set and the remaining 116 would be placed in a “high PAPR” set. When an SS determines that it is near the BS, it could select its ranging code from the “high PAPR” set. Only SSs that need additional power boosting (e.g., edge-of-cell user or a small battery powered device with a small PA) would select from the “low PAPR” set.

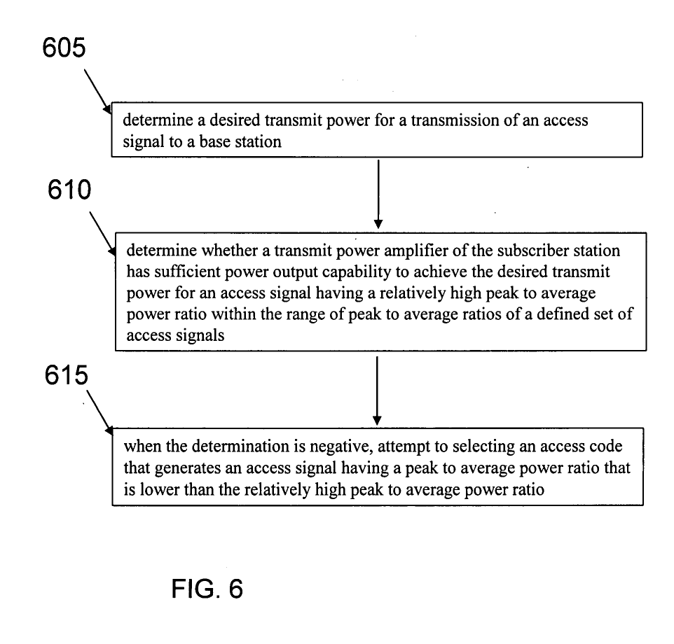

Referring to FIG. 6, a method is shown for selecting an access signal in accordance with some embodiments of the present invention tailored for a communication system that meets the current draft version of the IEEE 802.16 standard referred to above. At step 605, an SS that wants to transmit a ranging signal to a BS determines the desired transmit power for the transmission. This can be based on procedures already defined in the current draft version of the IEEE 802.16 standard referred to above, that utilize the measured received signal strength (i.e., received signal strength is a channel characteristic that is indicative of the range or path loss between the BS and SS). At step 610, the SS determines whether it has sufficient power amplifier (PA) output capability to achieve the desired transmit power, assuming that one of the ranging codes corresponding to a relatively high PAPR ranging signal is chosen from a defined set of access codes that correspond to a defined set of access codes. For example, if the range of PAPRs of the ranging signals generated from the ranging codes in the system is 7 to 11 dB, then a PAPR of 10 dB may be considered relatively high. Another value of a relatively high PAPR for this example, such as 9.5 dB, 10.5 dB, or 11 dB, that provides an acceptable probability of success when a random choice of the access code (and thereby, a random cboice of the access signal) is made may also be used. If the SS can achieve the desired power level with the relatively high PAPR ranging signal, then the ranging code is selected randomly as in the prior art. However, if the SS cannot achieve the desired power level, then the SS will attempt at step 615 to select a ranging code with a lower PAPR ranging signal than the relatively high value, so that the transmit power can be increased to meet or at least come closer to the desired transmit power. A specific procedure for selecting the ranging code is described below.

When a SS needs to select a ranging code having a low PAPR ranging signal, the selection needs to be done in a way that is not purely deterministic, since we do not want two SSs to always favor exactly the same ranging code (e.g., the ranging code with the lowest PAPR signal out of the entire group of codes). Also, we do not want to force an SS to evaluate the PAPR of every possible ranging code signal unless the SS chooses to do so. As a result, the proposed method for identifying and selecting a ranging code with a low PAPR ranging signal is scalable and provides a non-deterministic code selection:

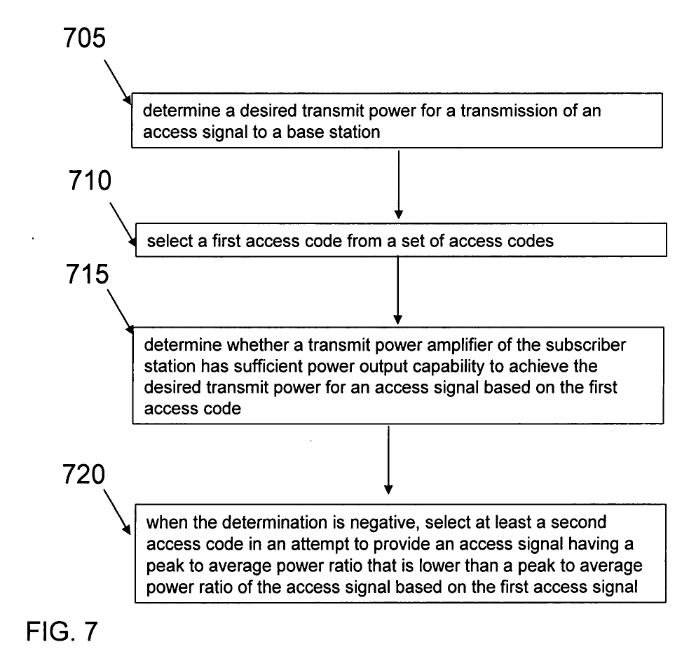

Whenever a new ranging code needs to be selected, the SS can randomly select Nr codes from the original set to create a first ranging code subset. The SS then identifies the Nrs<Nr codes having the lowest PAPR ranging signal from the first subset and puts them in a second subset (for example, when the number of codes in the original set is between 100 and 300, one method for selecting is Nrs=(floor(0.1*Nr)+floor((0.03*Nr)ˆ2)+1). Finally, the SS can randomly select one of the ranging codes from the second subset. The above procedure can be used for initial ranging, periodic ranging, or bandwidth requests. The ranging signal PAPR values are typically between 7-11 dB, so there is a potential gain of several dB with the present invention. Referring to FIG. 7, a flow chart show additional embodiments of the invention tailored for an 802.16 system, in accordance with some embodiments of the present invention. An SS that wants to transmit a ranging code to a BS determines the desired transmit power for the transmission and randomly selects a ranging code, referred to as a first ranging code. The desired transmit power can be based on procedures already defined in the 802.16 system specification that utilize the measured received signal strength (i.e., received signal strength is a channel characteristic that is indicative of the range between the BS and SS). The SS then determines whether it has sufficient power amplifier (PA) output capability to achieve the desired transmit power when transmitting a ranging signal using the first ranging code (e.g., based on the PAPR of the ranging signal and the output capability of the PA). If the SS can achieve the desired power level, then the first ranging code is selected and used. However, if the SS cannot achieve the desired power level, then the SS will attempt to select another ranging code with a lower PAPR ranging signal than the first ranging code, so that the transmit power can be increased to meet or at least come closer to the desired transmit power. The procedure for selecting another ranging code can be substantially the same as described above using on the first and second subsets of ranging codes of size Nrs and Nr. Alternatively, the SS may repeatedly make additional random ranging code selections until the currently selected ranging code has a low enough PAPR ranging signal for the SS to achieve or at least come closer to the desired transmit power. These additional embodiments can be summarized as a method used by a subscriber station for accessing a wireless multi-carrier communication system. A desired transmit power is determined, at step 705 (FIG. 7) for a transmission of an access signal to a base station. A first access code is selected from a set of access codes at step 710. A determinination is made at step 715 as to whether a transmit power amplifier of the subscriber station has sufficient power output capability to achieve the desired transmit power for an access signal based on the first access code. When the determination is negative, at least a second access code is selected at step 720 in an attempt to provide an access signal having a peak to average power ratio that is lower than a peak to average power ratio of the access signal based on the first access signal.

The power gain (i.e., the signal strength of the ranging signal received at the BS) achieved by the ranging code selection embodiments of the present invention described with reference to FIG. 5 may be less dramatic than the power gain achieved by the frequency sub-band selection embodiments of the present invention described with reference to FIGS. 1-4. For example, the power gains may be on the order of 3 dB for the ranging code selection embodiments. However, the ranging code selection embodiments are more widely applicable than the frequency sub-band selection embodiments since the ranging code selection embodiments are be used even in communication systems that do not use sub-banding on the ranging channel, such as communication systems that meet the current draft version of the IEEE 802.16 standard. In the current draft version of IEEE 802.16 standard, the PAPR of the ranging codes varies from 7.2 dB to 11.23 dB (4 dB of variation), and 50% of the codes have a PAPR below 8.5 dB. As a result, communication systems that meets the current draft version of the IEEE 802.16 standard could benefit from the ranging code selection method described. In some systems in which both the sub-band selection and ranging code selection embodiments of the present invention can be used, benefits greater than those achieved by either type of embodiment can be achieved.

Although signal strength measurements have been described as the channel characteristic used to determine a range of the SS from the BS, it will be appreciated that other channel characteristics could be used in combination with received signal strength, or as alternative characteristics. As an example, a measurement of received signal distortions may be appropriate for use in combination with a received signal strengths.

In some systems, such as the OFDM systems described above, the ranging codes relate to mathematical sequences that can be analyzed to generate a ranging waveform that low PAPR. In other systems, the ranging signal may not be related to a mathematical sequence that is susceptible to analysis, and the ranging signals may be analyzed in the time domain to determine the PAPRs. In this instance, the waveforms are directly coded or sorted according to their PAPRs and the selection of the ranging code (access code) in step 510 is synonymous with the selection of the waveform, and the generation of the waveform in step 515 from the ranging code is simply a action of identifying the waveform from the ranging code.

Although the present invention involves methods for communication system access, it is also applicable with minor modification to cases in which the uplink transmissions are assigned and anticipated by the BS. One example for such a case is the use of the invention to realize the function of an SS acknowledging the successful or unsuccessful reception of a message sent previously from the BS to the SS. In this case, a detection of the ranging code may correspond to some information, for example, the indicator of a successful reception. For the embodiments in which a ranging code is selected, the information can be associated with a ranging code in each of a plurality of sets of ranging codes associated with different classes of PAPRs.

It will be appreciated the base and subscriber stations described herein may be comprised of one or more conventional processors and unique stored program instructions that control the one or more processors to implement, in conjunction with certain non-processor circuits, some, most, or all of the functions of the base and subscriber stations described herein. The non-processor circuits may include, but are not limited to, a radio receiver, a radio transmitter, signal drivers, clock circuits, power source circuits, and user input devices. As such, these functions may be interpreted as steps of a method to perform accessing of a communication system. Alternatively, some or all functions could be implemented by a state machine that has no stored program instructions, in which each function or some combinations of certain of the functions are implemented as custom logic. Of course, a combination of the two approaches could be used. Thus, methods and means for these functions have been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

It is further understood that the use of relational terms, if any, such as first and second, top and bottom, and the like may be used solely to distinguish one entity or action from another entity or action without necessarily requiring or implying any actual such relationship or order between such entities or actions.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

1. A method used by a subscriber station for accessing a wireless multi-carrier communication system, comprising:
determining one or more channel characteristics of each frequency sub-band of a set of frequency sub-bands;
selecting a frequency sub-band of the set of frequency sub-bands based on the one or more channel characteristics;
forming an access signal; and
transmitting the access signal on the selected frequency sub-band.

2. The method according to claim 1, further comprising:
determining a rate of change of the one or more channel characteristics;
selecting a frequency sub-band of the set of frequency sub-bands randomly when the rate of change of the one or more channel characteristics is greater than a threshold.

3. The method according to claim 1, futher comprising:
determining one or more channel characteristics of a set of frequency sub-bands that is indicative of a range of the subscriber station from a base station;
selecting an access code that generates an access signal having a peak to average power ratio, using the one or more channel characteristics; and
generating the access signal from the access code.

4. The method according to claim 3, wherein the access signal is transmitted using a transmit signal power that is determined from the one or more channel characteristics.

5. A method used by a subscriber station for accessing a wireless multi-carrier communication system, comprising:
determining one or more channel characteristics that is indicative of a range of the subscriber station from a base station;
selecting an access code that generates an access signal having a peak to average power ratio, using the one or more channel characteristics;
generating an access signal from the access code; and
transmitting the access signal.

6. The method according to claim 5, wherein a relationship of the peak to average power ratio (PAPR) to the one or more channel characteristics is a monotonically decreasing relationship of the PAPR to a range estimate determined from the one or more channel characteristics of each frequency sub-band of the set of frequency sub-band.

7. The method according to claim 5, wherein the access signal is transmitted using a transmit signal power that is determined from the one or more channel characteristics.

8. The method according to claim 7, wherein a relationship of the transmit signal power to the one or more channel characteristics is a monotonically decreasing relationship of a monotonically decreasing relationship of the transmit power to a range estimate determined from the one or more channel characteristics.

9. The method according to claim 5, further comprising:
determining one or more channel characteristics of a frequency sub-band within each of a set of frequency sub-bands;
selecting a frequency sub-band of the set of frequency sub-bands based on the one or more channel characteristics; and
transmitting the access signal on the selected frequency sub-band.

10. A method used by a subscriber station for accessing a wireless multi-carrier communication system, comprising:
determining a desired transmit power for a transmission of an access signal to a base station;
determining whether a transmit power amplifier of the subscriber station has sufficient power output capability to achieve the desired transmit power for an access signal having a relatively high peak to average power ratio within the range of peak to average ratios of a defined set of access signals; and
when the determination is negative, attempting to select an access code that generates an access signal having a peak to average power ratio that is lower than the relatively high peak to average power ratio.

11. A method used by a subscriber station for accessing a wireless multi-carrier communication system, comprising:
determining a desired transmit power for a transmission of an access signal to a base station;
selecting a first access code from a set of access codes;
determining whether a transmit power amplifier of the subscriber station has sufficient power output capability to achieve the desired transmit power for an access signal based on the first access code; and
when the determination is negative, selecting at least a second access code in an attempt to provide an access signal having a peak to average power ratio that is lower than a peak to average power ratio of the access signal based on the first access signal.
